(19) United States
(12) Patent Application Publication
(10) Pub. No.: US 2018/0293377 A1
(43) Pub. Date: Oct. 11, 2018

(54) SUSPICIOUS BEHAVIOR DETECTION SYSTEM, INFORMATION-PROCESSING DEVICE, METHOD, AND PROGRAM

(71) Applicant: NEC Corporation, Tokyo (JP)

(72) Inventor: Yasuyuki TOMONAGA, Tokyo (JP)

(73) Assignee: NEC Corporation, Tokyo (JP)

(21) Appl. No.: 15/767,383

(22) PCT Filed: Oct. 5, 2016
(86) PCT No.: PCT/JP2016/079637

§ 371 Date: Apr. 11, 2018

(30) Foreign Application Priority Data
Oct. 13, 2015 (JP) 2015-202280

(51) Int. Cl. G06F 21/55; G06F 21/62; G06F 15/18

(52) U.S. Cl. CPC G06F 21/552; G06F 15/18; G06F 21/6281

(57) ABSTRACT

An information-processing device includes: model storage means 11 that stores an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed; and determination means 12 that determines whether arbitrary data access behavior is suspicious behavior based on the access behavior model.

### TECHNICAL FIELD

The present invention relates to a suspicious behavior detection system for detecting suspicious behavior, an information-processing device used therein, a suspicious behavior detection method, and a suspicious behavior detection program.

### BACKGROUND ART

In recent years, countermeasures against information leakage of corporate data have received particular attention. In particular, countermeasures against information leakage caused by stakeholders having effective access authority to data have been drawing attention.

This is because analysis of cases of information leakage of corporate data has revealed that in-house stakeholders having effective access authority to corporate data and persons in charge of outsourced work provided by the company trigger information leakage in many cases.

Typical examples of countermeasures against information leakage include a method of encrypting all data, a method of detecting and prohibiting a user's suspicious behavior on a rule basis, and a method of detecting and prohibiting a user's suspicious behavior on a statistical basis. Note that in the present invention, a user's act of accessing data by abusing the user's legitimate authority to the data is referred to as suspicious behavior. In the following description, a user's act of accessing data by legitimately using the user's legitimate authority to the data (within the scope of the purpose of setting the authority) may be referred to as normal behavior. In this case, the access behavior of a user having legitimate authority to certain data with respect to the data is classified as either normal behavior or suspicious behavior.

For example, PTL 1 describes an exemplary method for detecting a user's suspicious behavior on a statistical basis as mentioned above. More specifically, the system described in PTL 1 computes the transition of the operation state for each user regarding a predetermined operation in a predetermined time period from the operation log of the user. Then, the system generates a model including numerical values indicating the computed transition of the operation state, and calculates the average thereof. Then, the system detects a user who has performed a peculiar operation by calculating the divergence between the numerical value indicating the transition of the operation state of each user and the average.

In addition, in relation to a technique for obtaining a feature amount from data, NPL 1 describes a method for generating a feature vector by extracting features from a multidimensional vector consisting only of numerical values.

### CITATION LIST

### Patent Literature

PTL 1: Japanese Patent Application Laid-Open No. 2008-192091

### Non Patent Literature

NPL 1: Bespalov, Dmitriy and Qi, Yanjun and Bai, Bing and Shokoufandeh, Ali, “Sentiment Classification with Supervised Sequence Embedding”, Machine Learning and Knowledge Discovery in Databases, vol. 7523, 2012, pp. 159-174

### SUMMARY OF INVENTION

### Technical Problem

The above-mentioned method of encrypting all data is effective as a countermeasure against information leakage since encryption cannot be canceled unless a user uses dedicated software even if the user brings out data as it is. However, this method has a problem that leads to a reduction in productivity: it is necessary to request a super administrator who has the authority to cancel the encryption of data to cancel encryption each time a user wants to send data to a business partner in the ordinary course of business or the like. This method also has the problem of loopholes such as excluding a specific file from targets to be encrypted. This method has another problem: it is impossible to prevent a super administrator from abusing his/her authority to cancel the encryption of data.

Since rule-based methods such as analyzing access logs or the like and setting rules about access patterns to detect suspicious behavior can be applied to all users including a super administrator, there is a high possibility that information leakage due to a super administrator's abuse of authority can be prevented. However, this method has the problem of difficulty in setting rules in advance. This method has another problem: it takes time and labor to maintain the set rules.

Note that an exemplary statistical-based method includes, as described in PTL 1, calculating a feature amount correlated with a user's normal behavior (for example, the number of times a file server is accessed per minute, etc.), and detecting suspicious behavior when the feature amount exceeds a preset threshold. However, the method described in PTL 1 has the problem of a heavy load required for introduction since it is necessary to statistically analyze access logs in order to decide a feature amount correlated with a user's suspicious behavior or normal behavior. In addition, information on users and data subject to the statistical analysis of access logs often includes a large amount of various texts. In this case, the method described in PTL 1 uses a high-dimensional feature amount, but it is difficult to handle such a high-dimensional feature amount by statistical analysis. For this reason, the method described in PTL 1 has the problem of low detection accuracy of suspicious behavior.

In view of the above, an object of the present invention is to provide a suspicious behavior detection system capable of detecting suspicious behavior with a high degree of accuracy without setting rules in advance, an information-processing device used therein, a suspicious behavior detection method, and a suspicious behavior detection program.

### Solution to Problem

An information-processing device according to the present invention includes: model storage means that stores an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed; and determination means that determines whether arbitrary data access behavior is suspicious behavior based on the access behavior model.

A suspicious behavior detection system according to the present invention includes: learning means that generates through machine learning an access behavior model indicating a relationship between arbitrary access information and suspicious behavior or normal behavior, the access behavior model being generated using, as learning data, access information and information capable of determining whether data access behavior indicated by the access information is suspicious behavior, the access information being about data access behavior that is a user's behavior with respect to data, the access information including a first piece of information derived from the user who accesses the data and a second piece of information derived from the data accessed; model storage means that stores the access behavior model; determination means that determines whether arbitrary data access behavior is suspicious behavior based on the access behavior model; and suspicious behavior detection means that detects suspicious behavior from actual data access behavior based on a determination result.

A suspicious behavior detection method according to the present invention includes determining, by an information-processing device, whether arbitrary data access behavior is suspicious behavior based on an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed.

A suspicious behavior detection program according to the present invention causes a computer to execute a process of determining whether arbitrary data access behavior is suspicious behavior based on an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed.

### Advantageous Effects of Invention

According to the present invention, suspicious behavior can be accurately detected without setting rules in advance.

### BRIEF DESCRIPTION OF DRAWINGS

FIG. 1 It depicts a block diagram illustrating a configuration example of a suspicious behavior detection system according to a first exemplary embodiment.

FIG. 2 It depicts a flowchart illustrating an operation example of the suspicious behavior detection system according to the first exemplary embodiment.

FIG. 3 It depicts a block diagram illustrating another configuration example of the suspicious behavior detection system according to the first exemplary embodiment.

FIG. 4 It depicts a flowchart illustrating another operation example of the suspicious behavior detection system according to the first exemplary embodiment.

FIG. 5 It depicts a block diagram illustrating another configuration example of the suspicious behavior detection system according to the first exemplary embodiment.

FIG. 6 It depicts a block diagram illustrating a more detailed configuration example of numerical vector generation means 16.

FIG. 7 It depicts a block diagram illustrating a configuration example of a suspicious behavior detection system according to a second exemplary embodiment.

FIG. 8 It depicts an explanatory diagram illustrating an exemplary data structure of user data held by a user data storage unit 101.

FIG. 9 It depicts an explanatory diagram illustrating an exemplary data structure of document data held by a document data storage unit 102.

FIG. 10 It depicts an explanatory diagram illustrating an exemplary data structure of an access log held by an access log storage unit 105.

FIG. 11 It depicts an explanatory diagram illustrating an exemplary data structure of a prediction result held by a prediction score storage unit 112.

FIG. 12 It depicts a flowchart illustrating an operation example of an access behavior learning step of the suspicious behavior detection system 100.

FIG. 13 It depicts a flowchart illustrating an operation example of an access behavior prediction step of the suspicious behavior detection system 100.

FIG. 14 It depicts a flowchart illustrating an operation example of a suspicious behavior notification step of the suspicious behavior detection system 100.

FIG. 15 It depicts a block diagram illustrating a configuration example of a suspicious behavior detection system according to a first modification of the second exemplary embodiment.

FIG. 16 It depicts a flowchart illustrating an operation example of the suspicious behavior detection system according to the first modification of the second exemplary embodiment.

FIG. 17 It depicts a block diagram illustrating a configuration example of a suspicious behavior detection system according to a second modification of the second exemplary embodiment.

FIG. 18 It depicts an explanatory diagram illustrating an example of an access authority control screen.

FIG. 19 It depicts a flowchart illustrating an operation example of the suspicious behavior detection system according to the second modification of the second exemplary embodiment.

FIG. 20 It depicts a block diagram illustrating a configuration example of a suspicious behavior detection system according to a third modification of the second exemplary embodiment.

FIG. 21 It depicts a flowchart illustrating an operation example of the suspicious behavior detection system according to the third modification of the second exemplary embodiment.

### DESCRIPTION OF EMBODIMENTS

### Exemplary Embodiment 1

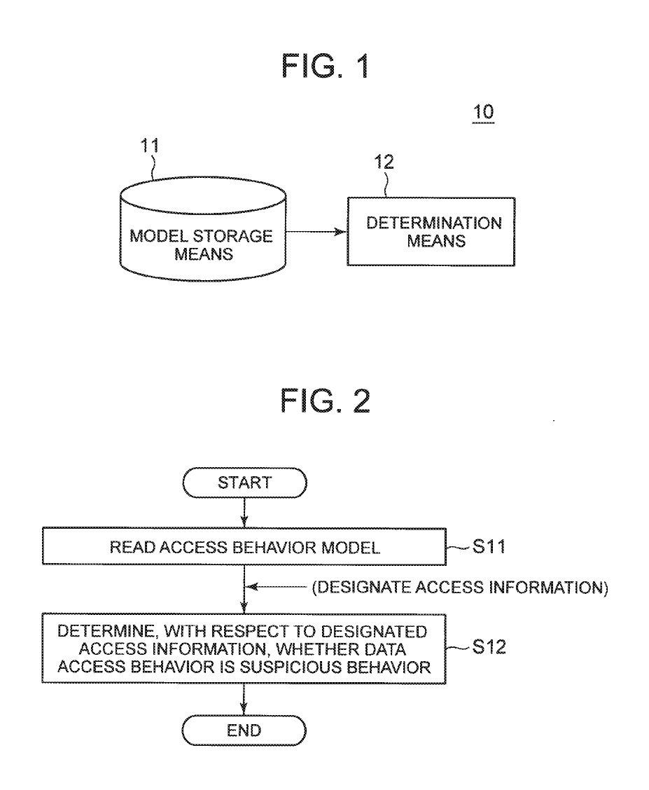

Hereinafter, exemplary embodiments of the present invention will be described with reference to the drawings. FIG. 1 is a block diagram illustrating a configuration example of a suspicious behavior detection system according to a first exemplary embodiment of the present invention. The suspicious behavior detection system 10 illustrated in FIG. 1 includes model storage means 11 and determination means 12.

The model storage means 11 stores an access behavior model indicating a relationship between access information and suspicious behavior or a relationship between access information and normal behavior. The access information is information about data access behavior that is a user's behavior with respect to data, and includes a first piece of information derived from the user who accesses the data and a second piece of information derived from the data accessed.

Based on the access behavior model stored in the model storage means 11, the determination means 12 determines whether arbitrary data access behavior is suspicious behavior.

Here, the first piece of information may be, for example, information on the user who accesses the data, information on the time (access time), type (access type), or method (access method) at/with which the user accesses the data. The second piece of information may be information on the accessed data itself (what is called the attribute information of data, information on the contents of data such as a feature amount, etc.). The second piece of information is not limited to information on the data itself, but may be, for example, information on a storage location of the data or a statistical value about access behavior performed on the data.

In addition, information on a user who accesses data is not limited to the information which is generally regarded as the attribute information of the user. For example, information on a user who accesses data may be information on a text generated by the user or a statistical value about access behavior performed by the user on predetermined data.

FIG. 2 is a flowchart illustrating an operation example of the present exemplary embodiment. In the example illustrated in FIG. 2, the determination means 12 first reads an access behavior model from the model storage means 11 (step S11). Next, based on the read access behavior model, the determination means 12 determines, with respect to designated access information, whether the data access behavior indicated by the access information is suspicious behavior (step S12).

As a method of acquiring access information, for example, the administrator may directly input access information, or the system may generate access information based on information on a designated period, data, users, and the like included in the access history for predetermined data.

According to such a configuration, it is possible to determine whether arbitrary access behavior is suspicious behavior based on an access behavior model capable of determining whether data access behavior is suspicious behavior from a set of information that is based on at least two aspects: information derived from a user who has accessed data and information derived from accessed data. Therefore, suspicious behavior can be detected with a high degree of accuracy without setting rules in advance.

In the configuration illustrated in FIG. 1, data may be a file managed by a file server. In such a case, the model storage means 11 may store an access behavior model learned through machine learning using access information about access behavior in a designated period among items of access behavior included in the access history for a predetermined file, and using information capable of determining whether the access behavior is suspicious behavior.

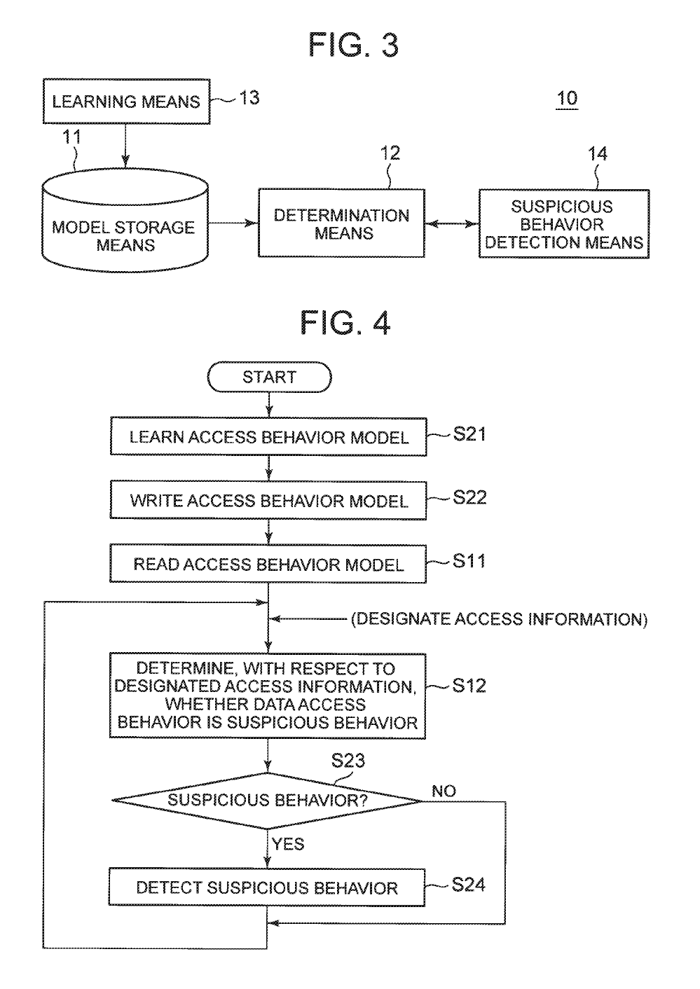

FIG. 3 is a block diagram illustrating another configuration example of the suspicious behavior detection system 10. As illustrated in FIG. 3, in addition to the components illustrated in FIG. 1, the suspicious behavior detection system 10 may further include, for example, learning means 13 that generates an access behavior model through machine learning using, as learning data, access information and information capable of determining whether the data access behavior indicated by the access information is suspicious behavior.

By providing the learning means 13, learning can be performed even when the number of dimensions of data given to the learning means is enormous. Note that the number of dimensions of data may be, for example, 1000 or more, or may be 10000 or more.

As illustrated in FIG. 3, the suspicious behavior detection system 10 may further include, for example, suspicious behavior detection means 14 that detects suspicious behavior from actual data access behavior based on the determination result by the determination means 12.

FIG. 4 is a flowchart illustrating an operation example of the suspicious behavior detection system 10 having the configuration illustrated in FIG. 3. In the example illustrated in FIG. 4, the learning means 13 first generates an access behavior model through machine learning using, as learning data, access information and information capable of determining whether the data access behavior indicated by the access information is suspicious behavior (step S21). The learning means 13 also writes the generated access behavior model into the model storage means 11 (step S22).

Next, the determination means 12 reads the access behavior model from the model storage means 11, and determines, with respect to designated access information, whether the data access behavior is suspicious behavior based on the read access behavior model (steps S11 and S12).

If the result of determination by the determination means 12 is suspicious behavior (Yes in step S23), the suspicious behavior detection means 14 determines that the access behavior indicated by the designated access information is suspicious behavior, and performs a predetermined detection process (step S24). The detection process may be, for example, a process of storing information on the detected suspicious behavior or notifying the administrator.

On the other hand, if the result of determination by the determination means 12 is not suspicious behavior (No in step S23), the system waits until the next access information is designated (returns to step S12).

The operation of steps S12 to S24 is repeated, for example, each time access information is designated.

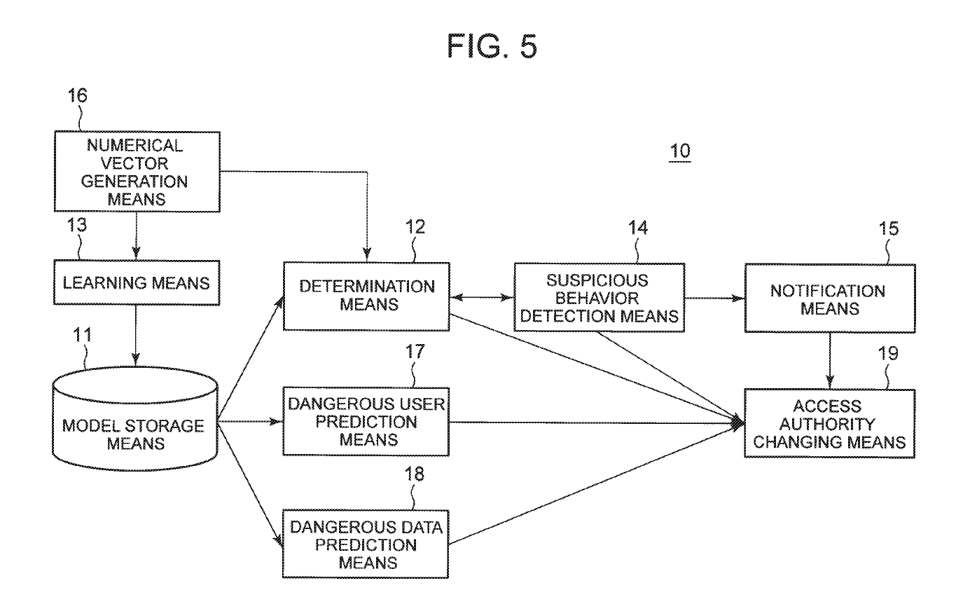

FIG. 5 is a block diagram illustrating another configuration example of the suspicious behavior detection system 10. As illustrated in FIG. 5, the suspicious behavior detection system 10 may further include, for example, a notification means 15, numerical vector generation means 16, dangerous user prediction means 17, dangerous data prediction means 18, and access authority changing means 19.

When suspicious behavior is detected, the notification means 15 notifies the administrator.

From access information, the numerical vector generation means 16 generates two or more numerical vectors, each including a multidimensional numerical value.

In the configuration including the numerical vector generation means 16, the model storage means 11 may store an access behavior model indicating a relationship between a set of numerical vectors generated by the numerical vector generation means 16 and suspicious behavior or normal behavior. Based on the probability, calculated using such an access behavior model, of suspicious behavior or normal behavior with respect to a set of two or more numerical vectors generated from designated access information, the determination means 12 may determine whether the data access behavior indicated by the access information is suspicious behavior.

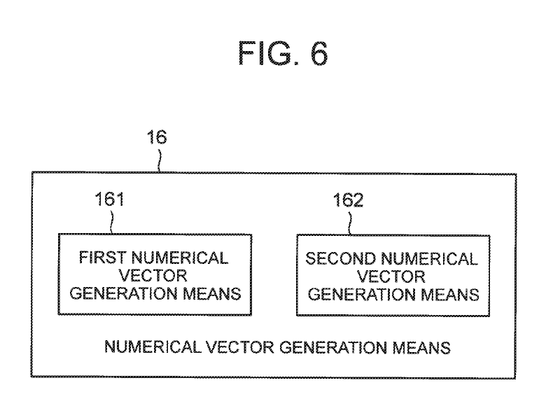

FIG. 6 is a block diagram illustrating a more detailed configuration example of the numerical vector generation means 16. As illustrated in FIG. 6, the numerical vector generation means 16 may include first numerical vector generation means 161 and second numerical vector generation means 162.

The first numerical vector generation means 161 generates a first numerical vector including a multidimensional numerical value from the first piece of information included in access information.

The second numerical vector generation means 162 generates a second numerical vector including a multidimensional numerical value from the second piece of information included in access information.

In the configuration including the first numerical vector generation means 161 and the second numerical vector generation means 162, the model storage means 11 may store an access behavior model indicating a relationship between a set of first numerical vector and second numerical vector and suspicious behavior or normal behavior. Based on the probability, calculated using such an access behavior model, of suspicious behavior or normal behavior with respect to a set of first numerical vector and second numerical vector generated from designated access information, the determination means 12 may determine whether the data access behavior indicated by the access information is suspicious behavior.

Based on the access behavior model, the dangerous user prediction means 17 predicts, with respect to data, a user who is at risk of performing data access behavior corresponding to suspicious behavior.

Based on the access behavior model, the dangerous data prediction means 18 predicts, with respect to a user, data that is at risk of undergoing access behavior corresponding to suspicious behavior.

The access authority changing means 19 changes access authority based on the determination result by the determination means 12, the detection result by the suspicious behavior detection means 14, the prediction result by the dangerous data prediction means 18, or the prediction result by the dangerous user prediction means 17.

According to such a configuration, it is possible not only to detect suspicious behavior with a high degree of accuracy, but also to notify the administrator of information on the detected suspicious behavior (such as access information used for detection). In addition, in order to prevent a user (suspicious behavior person) whose suspicious behavior has been detected from illegally acquiring the data (target data) associated with the detected suspicious behavior, the user's access authority to the target data can be automatically changed. In addition, since it is possible to predict users who may possibly perform such suspicious behavior and target data in advance, the occurrence of suspicious behavior can be prevented. Even if there is a hole in the data access authority setting, the hole can be closed.

In the present exemplary embodiment, the model storage means 11 is realized by, for example, a storage device. The determination means 12, the learning means 13, the suspicious behavior detection means 14, the notification means 15, the numerical vector generation means 16, the dangerous user prediction means 17, the dangerous data prediction means 18, and the access authority changing means 19 are realized by, for example, an information-processing device that operates in accordance with a program. Note that in a case where the notification means 15 notifies the administrator of information via a display device or the like, the notification means 15 may be realized by, for example, an information-processing device that operates in accordance with a program and a display device such as a display or an interface unit for the display device.

### Exemplary Embodiment 2

Next, a second exemplary embodiment of the present invention will be described.

Note that in the following description, the case where data targeted for suspicious behavior detection is a file managed by a file server will be described as an example, but data is not limited to a file managed by a file server. For example, data may be data of an arbitrary unit stored in a database system or the like.

First, the features of the present exemplary embodiment will be briefly described. The suspicious behavior detection system of the present exemplary embodiment uses three pieces of data: (1) user data of the file server, (2) document data stored in the file server, and (3) access log of the file server, to model each file server user's access behavior with respect to the file server at the normal time through machine learning (supervised learning). By continuously monitoring the divergence between each file server user's actual access behavior with respect to the file server and the access behavior predicted with the above model, a file server user with a large divergence is automatically detected as a suspicious behavior person.

Here, (1) user data may include, for example, name, age, sex, educational record, task, position, department, management span (span of control), transfer history, qualification, job history, performance evaluation, medical examination result, and the like. In addition, (2) document data may include, for example, property settings such as document name, file path, access authority, and update date, information on the contents of a document (text, images, etc.), and the like. In addition, (3) access log may be a file in which the access history for the file server is saved. Note that a large amount of various text data (unstructured data) may be included in any data.

In addition, a suspicious behavior detection method performed by the suspicious behavior detection system of the present exemplary embodiment includes five processes: a preprocessing step, a feature extraction step, a learning step, a prediction step, and a notification step.

In the preprocessing step, a data set (tuple) of <user attribute, document attribute, access record> is generated from the above three pieces of data (user data, document data, and access log). Here, the user attribute only needs to be the contents of the data item expressing the feature of a user extracted from the user data of the file server. The document attribute only needs to be the contents of the data item expressing the feature of a document extracted from the document data stored in the file server. The access record only needs to be information indicated by the access log of the file server and capable of determining the presence or absence of a record of the user's access to the document. For example, the access record may be binarized information indicating one when there is a record of access and indicating zero or the like when there is no record of access.

In the feature extraction step, a feature vector is generated from each of the user attribute and document attribute of the above data set.

In the learning step, after extracting the data sets corresponding to a learning target period from a group of data sets mentioned above, the relationship between elements (more specifically, the relationship between a pair of <user attribute, document attribute> and the access record) is learned through machine learning using these data sets to generate a prediction model. As a machine learning algorithm, it is assumed that the method (supervised semantic indexing (hereinafter referred to as SSI)) described in U.S. Pat. No. 8,341,095 is used, but other general machine learning methods may be combined.

In the prediction step, after extracting the data sets corresponding to a prediction target period from a group of data sets mentioned above, the prediction model is applied to these data sets. More specifically, the prediction score of access behavior is calculated for the pair of <user attribute, document attribute> indicated by each of the data sets. In the present exemplary embodiment, the prediction score is a real value of [0.0 to 1.0]. Note that as the prediction score is closer to 1.0, a pair of <user attribute, document attribute> indicates a higher access probability, indicating that the behavior is more likely to be normal behavior. On the other hand, as the prediction score is closer to 0.0, a pair of <user attribute, document attribute> indicates a lower access probability, indicating that the behavior is more likely to be suspicious behavior.

In the notification step, from the pairs of <user attribute, document attribute> subjected to calculation in the prediction step, a pair having a prediction score lower than a threshold (for example, 0.1 or the like) (in other words, a pair predicted to have a low probability that the user indicated by the user attribute accesses the document indicated by the document attribute) is extracted as suspicious behavior. Then, the administrator or the like is notified of a list of users associated with the extracted suspicious behavior.

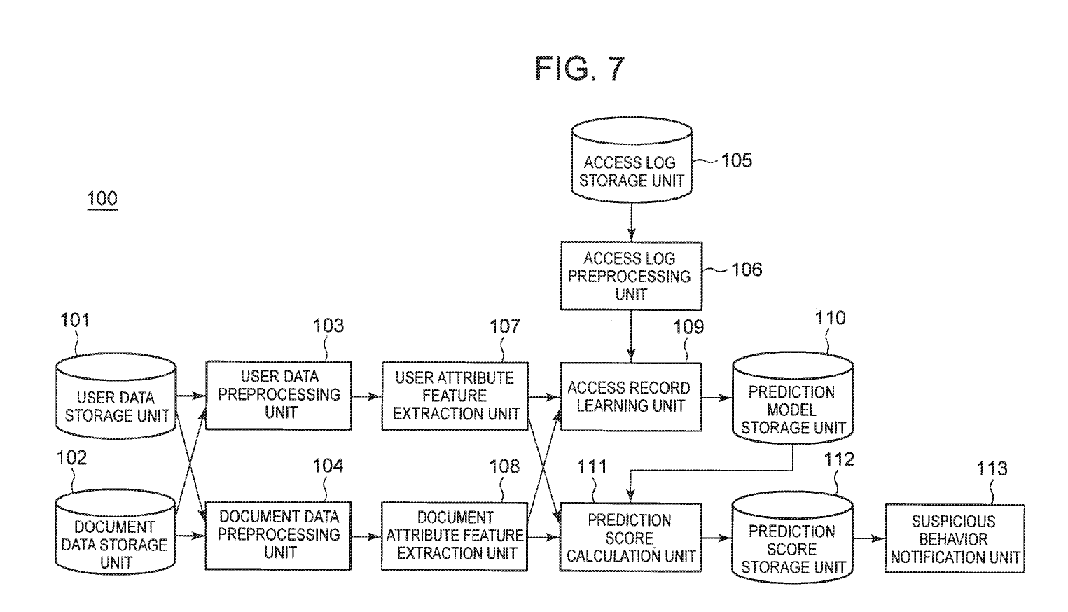

A more detailed configuration will be described below. FIG. 7 is a block diagram illustrating a configuration example of the suspicious behavior detection system according to the present exemplary embodiment.

The suspicious behavior detection system 100 illustrated in FIG. 7 includes a user data storage unit 101, a document data storage unit 102, a user data preprocessing unit 103, a document data preprocessing unit 104, an access log storage unit 105, an access log preprocessing unit 106, a user attribute feature extraction unit 107, a document attribute feature extraction unit 108, an access record learning unit 109, a prediction model storage unit 110, a prediction score calculation unit 111, a prediction score storage unit 112, and a suspicious behavior notification unit 113.

The suspicious behavior detection system 100 is realized by, for example, an information-processing device such as a personal computer and a server device and a group of storage devices such as a database system accessible by the information-processing device. At this time, the user data preprocessing unit 103, the document data preprocessing unit 104, the access log preprocessing unit 106, the user attribute feature extraction unit 107, the document attribute feature extraction unit 108, the access record learning unit 109, the prediction score calculation unit 111, and the suspicious behavior notification unit 113 may be realized by, for example, a CPU included in the information-processing device. In that case, the CPU reads a program describing the operation of each processing unit stored in a predetermined storage device, and realizes the function of each processing unit by operating in accordance with the program. The user data storage unit 101, the document data storage unit 102, the access log storage unit 105, the prediction model storage unit 110, and the prediction score storage unit 112 may be realized by, for example, a group of storage devices accessible by the information-processing device. Note that the number of storage devices may be one or more.

The user data storage unit 101 holds the user data of users of the file server. Examples of items of the user data of the file server include name, age, sex, educational record, task, position, department, management span, transfer history, qualification, job history, performance evaluation, medical examination result, and the like.

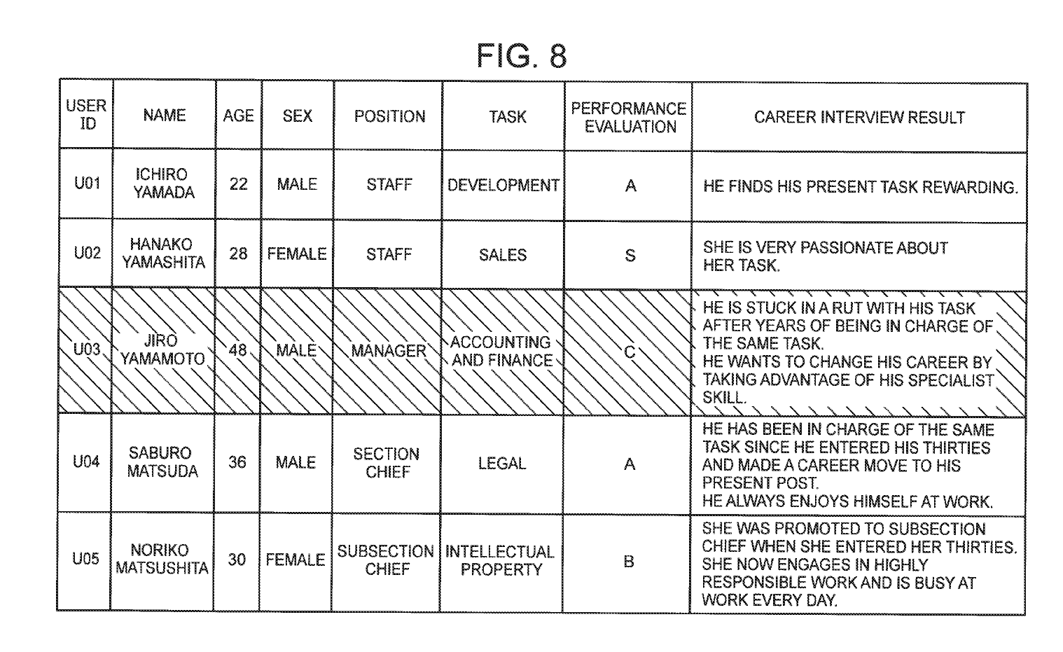

FIG. 8 is an explanatory diagram illustrating an exemplary data structure of the user data held by the user data storage unit 101. As illustrated in FIG. 8, the user data storage unit 101 may store, as user data, information such as a user's name, age, sex, position, task, and performance evaluation, for example, in association with a user ID for identifying the user. The user data may further include information describing a user's personality and work attitude in a text format. The user data may further include a medical examination result. Note that shading in FIG. 8 indicates an exemplary record corresponding to the user data of a single user.

The document data storage unit 102 holds the document data of documents stored in the file server. Examples of items of the document data include property settings associated with a document, such as document name, document type, file path, access authority, and update date.

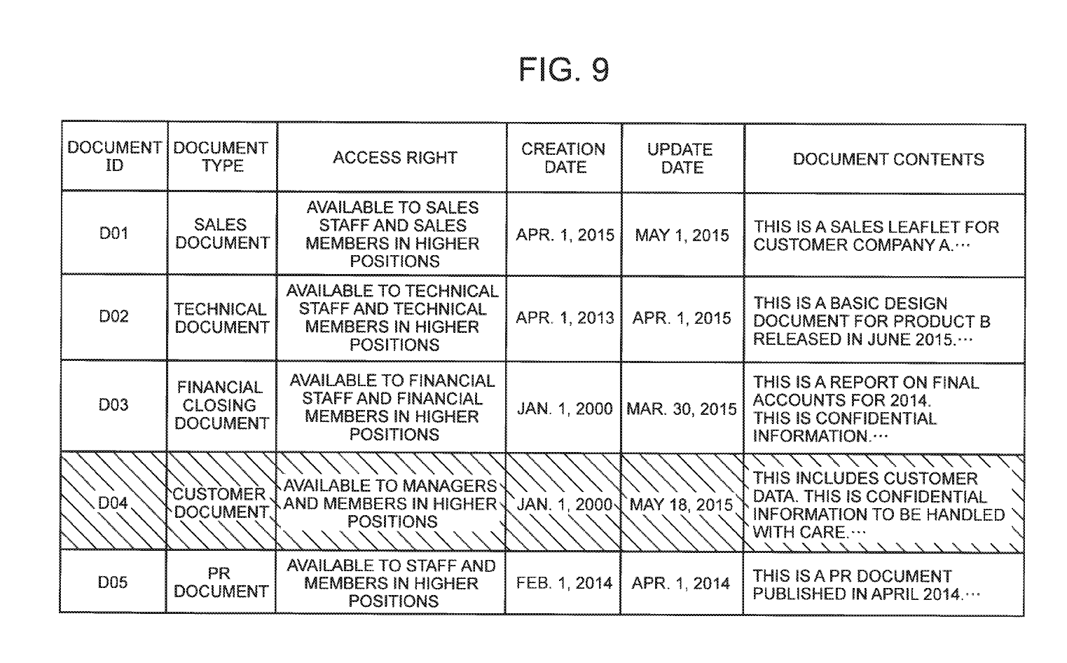

FIG. 9 is an explanatory diagram illustrating an exemplary data structure of the document data held by the document data storage unit 102. As illustrated in FIG. 9, the document data storage unit 102 stores, as document data, property information such as document type, setting contents of access authority, creation date, and update date, for example, in association with a document ID for identifying the document. The document data may further include information describing the contents of a document in a text format. Note that shading in FIG. 9 indicates an exemplary record corresponding to the document data of a single file.

The user data preprocessing unit 103 refers to the user data storage unit 101 and reads a record related to a designated user. The user data preprocessing unit 103 also generates a user vector by using information on the designated user (hereinafter may be referred to as user attribute information) included in the read record. Here, the user vector expresses the contents indicated by the user attribute information by a multidimensional vector including numerical values. For example, the user data preprocessing unit 103 performs the above processing according to a command from the user attribute feature extraction unit 107.

The document data preprocessing unit 104 refers to the document data storage unit 102 and reads a record related to a designated document. The document data preprocessing unit 104 also generates a document vector by using information on the designated document (hereinafter may be referred to as document attribute information) included in the read record. Here, the document vector expresses the contents indicated by the document attribute information by a multidimensional vector including numerical values. For example, the document data preprocessing unit 104 performs the above processing according to a command from the document attribute feature extraction unit 108.

The access log storage unit 105 holds the access log of a predetermined file server. Each time a file server user accesses the file server, the access log of the file server records information on access behavior such as access date, access person, and access document.

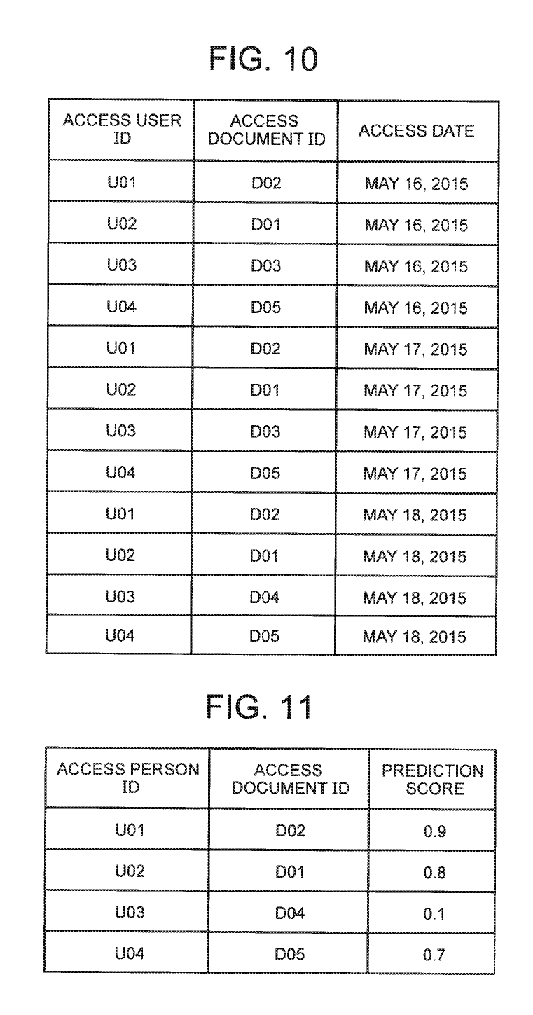

FIG. 10 is an explanatory diagram illustrating an exemplary data structure of the access log held by the access log storage unit 105.

The access log preprocessing unit 106 refers to the access log storage unit 105 and reads a record having an access date in a designated period. The access log preprocessing unit 106 also generates label information based on the access person ID and the access document ID included in the read record. For example, the access log preprocessing unit 106 may use the set of access person ID and access document ID included in the record during the designated period of the access log to generate label information <user ID, document ID, correct/incorrect label (0/1)> including a correct/incorrect label of correct (1) for the set of user ID corresponding to the access person ID and document ID corresponding to the access document ID. The access log preprocessing unit 106 may randomly select, for example, a set of user and document having no access record during the designated period of the access log to generate label information including a correct/incorrect label of incorrect (0) for the set of user ID of the user and document ID of the document. Note that the access log preprocessing unit 106 may generate, as correct label information, label information <user ID, document ID> indicating a set of user who has performed normal behavior and document, or generate, as incorrect label information, label information <user ID, document ID> indicating a set of user who has performed suspicious behavior and document. In the following description, correct label information and incorrect label information may be referred to as correct/incorrect label information, which means label information capable of determining whether behavior is suspicious behavior, without being distinguished from each other. For example, the access log preprocessing unit 106 performs the above processing according to a command from the access record learning unit 109.

The user attribute feature extraction unit 107 extracts features from the user vector generated by the user data preprocessing unit 103 to generate a user feature vector. Here, the user feature vector only needs to be a numerical vector whose number of dimensions is smaller than the number of dimensions of the user vector. For example, the user attribute feature extraction unit 107 performs the above processing according to a command from the access record learning unit 109 or the prediction score calculation unit 111.

The document attribute feature extraction unit 108 extracts features from the document vector generated by the document data preprocessing unit 104 to generate a document feature vector. Here, the document feature vector only needs to be a numerical vector whose number of dimensions is smaller than the number of dimensions of the document vector. For example, the document attribute feature extraction unit 108 performs the above processing according to a command from the access record learning unit 109 or the prediction score calculation unit 111.

Based on the user feature vector generated by the user attribute feature extraction unit 107, the document feature vector generated by the document attribute feature extraction unit 108, and the label information generated by the access log preprocessing unit 106, the access record learning unit 109 generates <user feature vector, document feature vector, correct/incorrect label (1/0)> as learning data. Note that the label information may be label information including a correct/incorrect label (<user ID, document ID, correct/incorrect label>), or may be correct/incorrect label information that does not include a correct/incorrect label (<user ID, document ID>). The access record learning unit 109 also learns through machine learning the relationship between the user feature vector, the document feature vector, and the correct/incorrect label by using the generated learning data, and generates a prediction model.

The prediction model storage unit 110 holds the prediction model generated by the access record learning unit 109.

The prediction score calculation unit 111 generates prediction data <user feature vector, document feature vector> for a designated pair of user and document. The prediction score calculation unit 111 also calculates a prediction score of access behavior for the prediction data by applying the prediction model held by the prediction model storage unit 110 to the generated prediction data. For example, the prediction score calculation unit 111 may generate elements of prediction data by designating a user and document and instructing the user data preprocessing unit 103, the user attribute feature extraction unit 107, the document data preprocessing unit 104, and the document attribute feature extraction unit 108.

The prediction score storage unit 112 holds the prediction result (calculation result of the prediction score) by the prediction score calculation unit 111 together with the information of the user and document used for prediction.

FIG. 11 is an explanatory diagram illustrating an exemplary data structure of a prediction result held by the prediction score storage unit 112. As illustrated in FIG. 11, the prediction score storage unit 112 stores calculated prediction scores, for example, together with access person IDs for identifying accessing users and access document IDs for identifying accessed data.

The suspicious behavior notification unit 113 refers to the prediction score storage unit 112 and extracts a record whose prediction score is lower than a threshold (for example, 0.1 or the like) (that is, a record predicted to have a low access probability) as suspicious behavior. The suspicious behavior notification unit 113 also notifies the administrator or the like of a list of users associated with the extracted suspicious behavior using a predetermined method.

Next, the operation of the present exemplary embodiment will be described. The operation of the suspicious behavior detection system 100 of the present exemplary embodiment is roughly classified into three steps: an access behavior learning step, an access behavior prediction step, and a suspicious behavior notification step.

In the access behavior learning step, the access record learning unit 109 generates learning data based on the user feature vector generated by the user attribute feature extraction unit 107, the document feature vector generated by the document attribute feature extraction unit 108, and the label information generated by the access log preprocessing unit 106, and generates a prediction model by learning through machine learning the relationship between the elements of the learning data, more specifically the relationship between the set of user feature vector and document feature vector and a correct/incorrect label. The access record learning unit 109 also writes the generated prediction model into the prediction model storage unit 110.

In the behavior prediction step, the prediction score calculation unit 111 applies a prediction model to a set of user feature vector and document feature vector for a designated user and document, and calculates a probability that the user accesses the document as a prediction score. The prediction score calculation unit 111 also writes the calculated prediction score into the prediction score storage unit 112 together with the information of the user and document used for calculation.

In the suspicious behavior notification step, the suspicious behavior notification unit 113 extracts, from the prediction score storage unit 112, a record whose prediction score is lower than the threshold as suspicious behavior, and outputs a list of information on the extracted suspicious behavior.

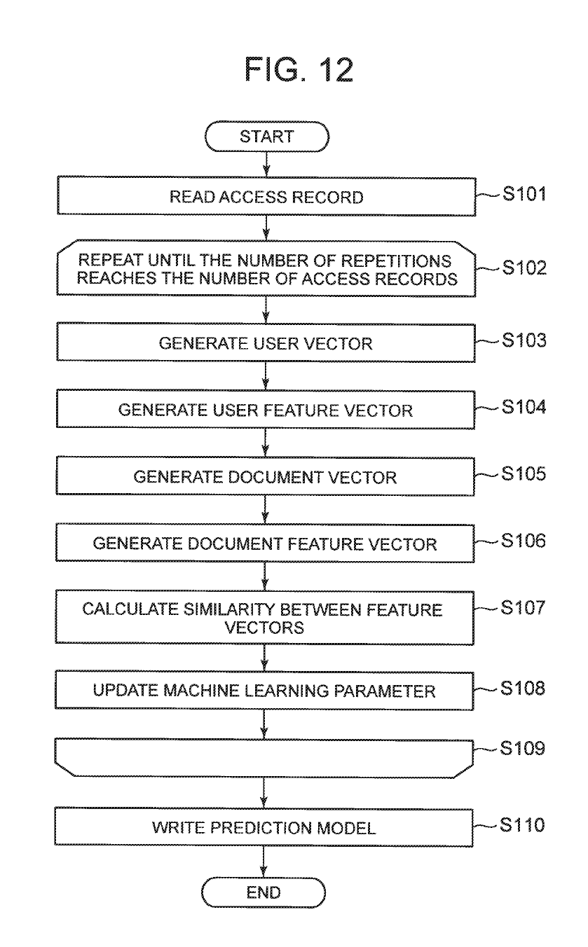

FIG. 12 is a flowchart illustrating an operation example of the access behavior learning step of the suspicious behavior detection system 100. In the example illustrated in FIG. 12, the access record learning unit 109 first drives the access log preprocessing unit 106 to read a record having an access date in a designated period (that is, a learning period) from the access log (step S101).

In step S101, the access log preprocessing unit 106 may read, for example, from the access log storage unit 105, a record whose access date matches a condition as an access record, and generate a correct label <user ID, document ID, correct label (1)>. The access log preprocessing unit 106 may also randomly select a document ID having no access record for the user ID included in the read record, for example, and generate an incorrect label <user ID, document ID, incorrect label (0)>.

Next, the access record learning unit 109 repeats the operation of steps S103 to S108 until the number of repetitions reaches the number of access records (steps S102 and S109).

In step S103, the access record learning unit 109 drives the user data preprocessing unit 103 to read user attribute information which is the user data of the user ID of the access record read in step S101. The user data preprocessing unit 103 also converts the contents (user attribute information) of the read record into a vector format to generate a user vector.

The vectorization (numerical conversion) of the user attribute information is performed as follows, for example. That is, among the user attribute information, for data of a code item which is an item with a predetermined value range such as age, age, final educational record, and qualification, the user data preprocessing unit 103 may set a predetermined vector element value at one if the contents of the code item falls within the predetermined range and at zero if the contents of the code item does not fall within the predetermined range (binarization).

In addition, among the user attribute information, for example, for data of a text item which is an item in a text format, the user data preprocessing unit 103 may segment the text as the contents of the text item into words using morpheme analysis or the like, and count the frequency or the like of words or word groups in the entire text. Frequency may be counted for a group of words ranging from two to five words, rather than for every single word. The optimum number of words depends on the number of users and documents to be learned. The user data preprocessing unit 103 may also set, for example, the counted frequency as a vector element value corresponding to the word or word group.

In the model learning step, in some cases, the model is learned again, with a part of the learning target data (sets of document feature vectors and user feature vectors) removed from the learning target, in order to verify the accuracy at the time of updating a machine learning parameter (to be described later). At that time, the user data preprocessing unit 103 may determine the optimum number of words by changing the number of words and performing verification. The user data preprocessing unit 103 may also restrict words to be subjected to frequently counting, for example, by excluding words, e.g., particles, which frequently appear in all documents. In this way, a numerical vector (data sequence consisting only of numerical values) expressing the feature of the text, that is, the feature of the user who wrote the text, is generated.

Note that texts or the like posted by users on web sites and SNS can also be converted into data (numerical values) representing features of users. In recent years, since things that many people are interested in are written in SNS, blogs, etc., it is possible to generate numerical vectors containing many features of users by using these pieces of information.

Using a method similar to the above method of numerically converting text, the user data preprocessing unit 103 may also segment the URL names of access destinations and count the frequency or residence time of words and word groups included therein, or may segment the HTTP documents at URL destinations and count the frequency of included words and word groups. Such results of counting related to the web access history can also be vectorized (numerically converted).

In step S104, the access record learning unit 109 drives the user attribute feature extraction unit 107 to extract features from the user vector generated in step S103 and generate a user feature vector.

Generally, a user vector generated in step S103 is data with a very large vector length.

For this reason, it is difficult to apply the user vector as it is to learning and prediction on the latter stage. Therefore, in the present exemplary embodiment, by using the user attribute feature extraction unit 107, only the characteristic data item of the user attribute information is selected, and a vector with a compressed data length is generated.

For example, the user attribute feature extraction unit 107 may generate a feature vector using the method described in NPL 1 above. Note that the method described in NPL 1 generates a feature vector completely automatically. Alternatively, first, an important vector term may be manually analyzed through principal component analysis or the like, and such a vector term may be designated. In such a case, the user attribute feature extraction unit 107 may generate a feature vector expressing the contents of the vector term.

In step S105, the access record learning unit 109 drives the document data preprocessing unit 104 to read the document data (document attribute information) of the document ID of the access record read in step S101. The document data preprocessing unit 104 reads a record with a matching document ID from the document data storage unit 102, converts the record into a vector format, and generates a document vector. The vectorization (numerical conversion) of the document attribute information can be performed by applying a method similar to that for the vectorization of the user attribute information described in step S103.

In step S106, the access record learning unit 109 drives the document attribute feature extraction unit 108 to extract features from the document vector generated in step S105 and generate a document feature vector. The feature extraction from the document vector can be performed by applying a method similar to that for the feature extraction from the user vector described in step S104.

In step S107, the access record learning unit 109 calculates the cosine similarity between the user feature vector generated in step S104 and the document feature vector generated in step S106 as preprocessing for learning. Note that in the present example, cosine similarity is used as a metric for measuring the similarity between two vectors, but any other norms (L1 norm, L2 norm, etc.) can also be used.

In step S108, the access record learning unit 109 adjusts the machine learning parameter using the similarity calculated in step S107 and the label information generated in step S101.

Note that in the present example, the above-described SSI is assumed as means of machine learning, but any supervised machine learning classifier can be applied. Support vector machines, neural networks, Bayes classifiers, etc. are widely-known examples of supervised machine learning classifiers.

The suspicious behavior detection system repeats the above processing until the number of repetitions reaches the number of access records, and proceeds to step S110.

In step S110, the access record learning unit 109 writes the machine learning parameter adjusted in step S108 into the prediction model storage unit 110.

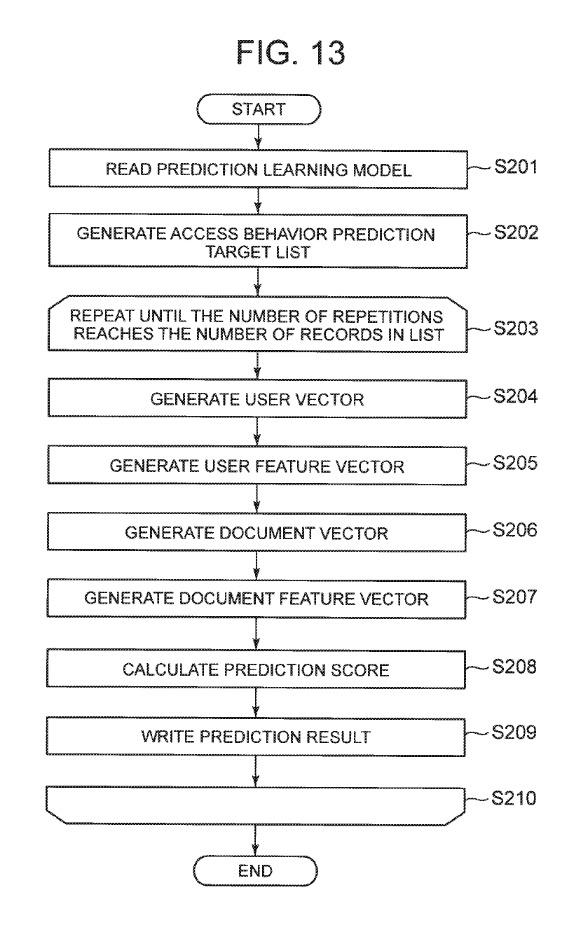

FIG. 13 is a flowchart illustrating an operation example of the access behavior prediction step of the suspicious behavior detection system 100.

In the example illustrated in FIG. 13, the prediction score calculation unit 111 first reads the adjusted machine learning parameter written in step S110 from the prediction model storage unit 110 (step S201).

Next, the prediction score calculation unit 111 drives the access log preprocessing unit 106 to read a record having an access date in a designated period (prediction period) from the access log (step S202). In step S202, the access log preprocessing unit 106 generates a list of label information <user ID, document ID, correct/incorrect label> based on the read record group. Hereinafter, the list of label information generated here may be referred to as an access behavior prediction target list.

Next, the prediction score calculation unit 111 repeats the processing of steps S204 to S209 until the number of repetitions reaches the number of records included in the list generated in step S202 (steps S203 and S210).

In step S204, the prediction score calculation unit 111 sequentially retrieves pieces of label information included in the access behavior prediction target list. Then, the prediction score calculation unit 111 drives the user data preprocessing unit 103 to read the user data of the user indicated by the user ID included in the retrieved label information. In step S204, the user data preprocessing unit 103 reads a record (user attribute information) matching the designated user ID from the user data storage unit 101, converts the record into a vector format, and generates a user vector. The method of vectorizing (numerically converting) the user attribute information may be the same as the method described in step S103.

In step S205, the prediction score calculation unit 111 drives the user attribute feature extraction unit 107 to extract features from the user vector generated in step S204 and generate a user feature vector. The method of extracting features from the user vector may be the same as the method described in step S104.

In step S206, the prediction score calculation unit 111 drives the document data preprocessing unit 104 to read the document data of the document indicated by the document ID included in the label information extracted in step S204. In step S206, the document data preprocessing unit 104 reads a record (document attribute information) matching the designated document ID from the document data storage unit 102, converts the record into a vector format, and generates a document vector. The method of vectorizing (numerically converting) the document attribute information may be the same as the method described in step S103.

In step S207, the prediction score calculation unit 111 drives the document attribute feature extraction unit 108 to extract features from the document vector generated in step S206 and generate a document feature vector. The method of extracting features from the document vector may be the same as the method illustrated in step S104.

In step S208, using the user feature vector generated in step S205 and the document feature vector generated in step S207, the prediction score calculation unit 111 calculates, based on the machine learning parameter read in step S201, the access probability for the set of user feature vector and document feature vector as a prediction score. As described above, in this example, the prediction score is a real value of [0.0 to 1.0]. The prediction score may be, for example, a numerical value called the probability (certainty factor, reliability) of a support vector machine.

In step S209, the prediction score calculation unit 111 writes the prediction result into the prediction score storage unit 112 together with the prediction score calculated in step S208 and the set of user and document subjected to prediction score calculation. The prediction score calculation unit 111 may write the prediction result into the prediction score storage unit 112 in the form of <user ID, document ID, prediction score>.

The above processing is repeated until the number of repetitions reaches the number of records included in the access behavior prediction target list, and the behavior prediction step is finished.

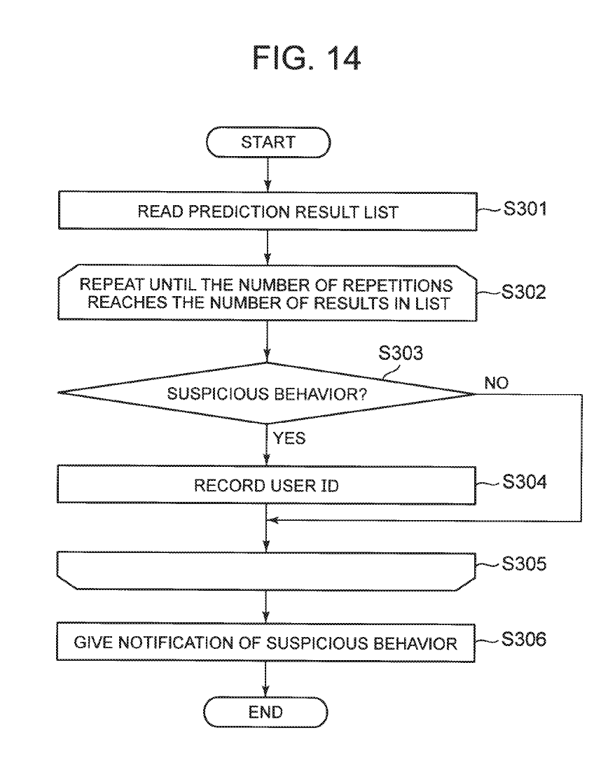

FIG. 14 is a flowchart illustrating an operation example of the suspicious behavior notification step of the suspicious behavior detection system 100.

In the example illustrated in FIG. 14, the suspicious behavior notification unit 113 first reads a prediction result list that is a list of prediction results <user ID, document ID, prediction score> (step S301).

Next, the suspicious behavior notification unit 113 repeats the processing of steps S303 to S304 until the number of repetitions reaches the number of prediction results included in the prediction result list (steps S302 and S305).

In step S303, the suspicious behavior notification unit 113 compares the prediction score of the record read in step S301 with a preset threshold (for example, 0.1 or the like). Here, if the prediction score of the read record is less than the predetermined threshold, the suspicious behavior notification unit 113 determines that the access behavior associated with the set of user and document indicated by the record is suspicious behavior (Yes in step S303). Then, the suspicious behavior notification unit 113 proceeds to step S304. On the other hand, if the prediction score of the read record is equal to or more than the predetermined threshold, the suspicious behavior notification unit 113 determines that the access behavior associated with the set does not correspond to suspicious behavior, that is, the access behavior is normal behavior (No in step S303). Thereafter, the suspicious behavior notification unit 113 does not perform any particular processing, and returns to step S303 to shift the processing to the next record in the list.

In step S304, the suspicious behavior notification unit 113 temporarily stores information of at least the user (user ID) from the set of user and document regarded as suspicious behavior. Note that the suspicious behavior notification unit 113 may store not only information of the user but also information of the document (document ID), the calculated prediction score, and the like. At this time, if the same information has already been registered through the repetitive processing, the suspicious behavior notification unit 113 does not have to register again.

Upon completion of the above processing for all the prediction results in the list, the suspicious behavior notification unit 113 reads the information registered in the temporary storage in step S304 and notifies the administrator or the like as suspicious behavior (step S306). The suspicious behavior notification unit 113 may notify the administrator or the like of the user indicated by the user ID included in the information registered in the temporary storage as a suspicious behavior person, for example. Further, for example, the suspicious behavior notification unit 113 may notify the administrator or the like of the document indicated by the document ID included in the information registered in the temporary storage as a dangerous document on which access behavior different from normal behavior is performed.

As described above, in the present exemplary embodiment, a prediction model for suspicious behavior is generated using user data that is information of a user who accesses data, document data that is information of the data itself, and an access log, and suspicious behavior is detected based on the generated prediction model. The generated prediction model can therefore handle a larger amount of data than models or the like generated on a statistical basis, enabling more accurate detection.

First Modification.

In the configuration described in the above exemplary embodiment, the processing is finished by giving a notification of detected suspicious behavior. Alternatively, the suspicious behavior detection system can automatically change the setting of the access authority to target data for a user whose suspicious behavior has been detected. In this way, by automatically closing a hole in the access authority, it is possible to proactively suppress a file server user's act of illegally bringing out data.

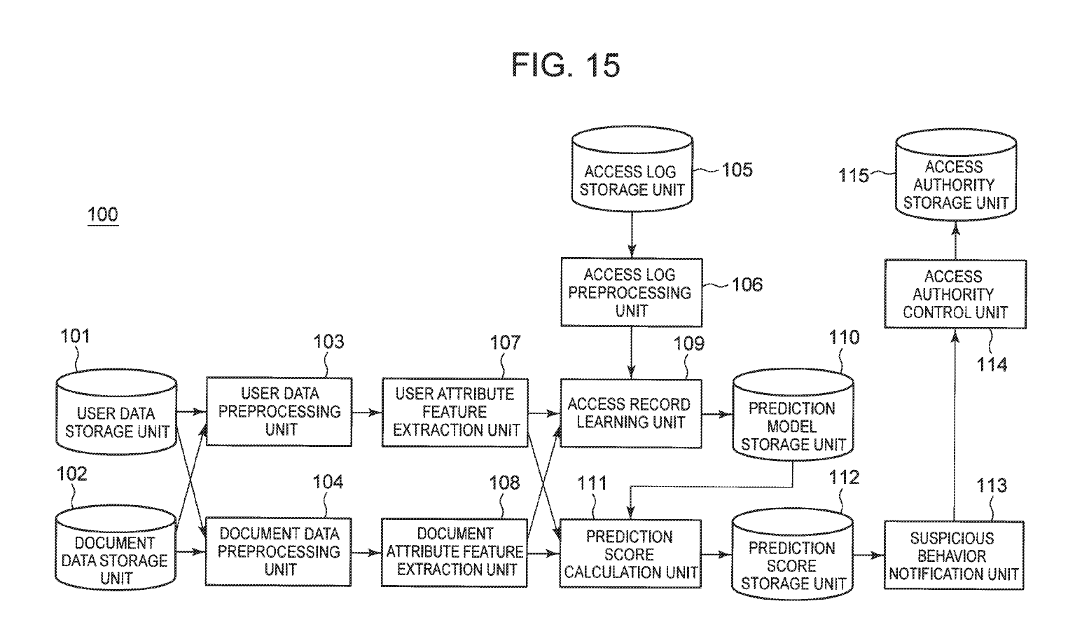

FIG. 15 is a block diagram illustrating a configuration example of a suspicious behavior detection system according to the present modification. The suspicious behavior detection system 100 illustrated in FIG. 15 differs from the configuration illustrated in FIG. 7 in that it further includes an access authority control unit 114 and an access authority storage unit 115.

The access authority control unit 114 performs control such as setting and changing of the access authority applied to predetermined data including data targeted for suspicious behavior detection.

The access authority storage unit 115 holds at least information of the current access authority applied to predetermined data including data targeted for suspicious behavior detection.

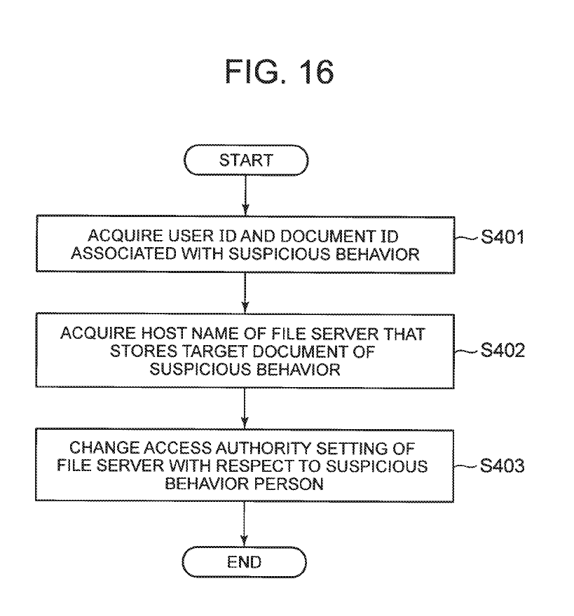

FIG. 16 is a flowchart illustrating an operation example of the suspicious behavior detection system according to the present modification. In the present modification, an access authority control step is further included in addition to the above configuration. Note that FIG. 16 illustrates an operation example of the access authority control step of the suspicious behavior detection system 100 according to the present modification.

In the access authority control step, based on information of suspicious behavior detected based on the calculation result of the prediction score by the access behavior prediction step, the access authority is controlled such that the user who has performed the suspicious behavior cannot perform similar access behavior. For example, the access right may be controlled such that a user whose suspicious behavior has been detected is prohibited from accessing the data associated with the detected suspicious behavior. For example, the access authority control unit 114 may acquire the user ID and the document ID from the information of suspicious behavior, acquire the host name of the file server that stores the document, and set the access authority in order to make the user indicated by the user ID inaccessible to the document (data) indicated by the document ID.

In the example illustrated in FIG. 16, the access authority control unit 114 first acquires information on the detected suspicious behavior from the suspicious behavior notification unit 113 (step S401).

Next, the access authority control unit 114 acquires the host name of the file server that stores the target document of the suspicious behavior (step S402).

Next, the access authority control unit 114 changes the access authority setting of the file server or the target document of the suspicious behavior with respect to the suspicious behavior person (step S403). Note that there is no particular limitation on how to change the access authority setting. For example, a commonly used method may be used. For example, in a case where the access authority setting is managed by a directory service (Active Directory or LDAP in the case of Windows (registered trademark)), a method of changing the access authority setting of the file server or the like via the service can be used.

Second Modification.

In the example described in the first modification, a hole in the access authority setting is automatically closed based on the detected suspicious behavior. Alternatively, the system can suggest, to a specific user such as a person in charge of operation, not only information of suspicious behavior but also changing the setting of the access authority related to the suspicious behavior, and control the access authority after waiting for a response. Consequently, in the actual operation, it is possible to prevent on-the-spot operation from falling into confusion due to automatic changes in the access authority setting of data and file servers.

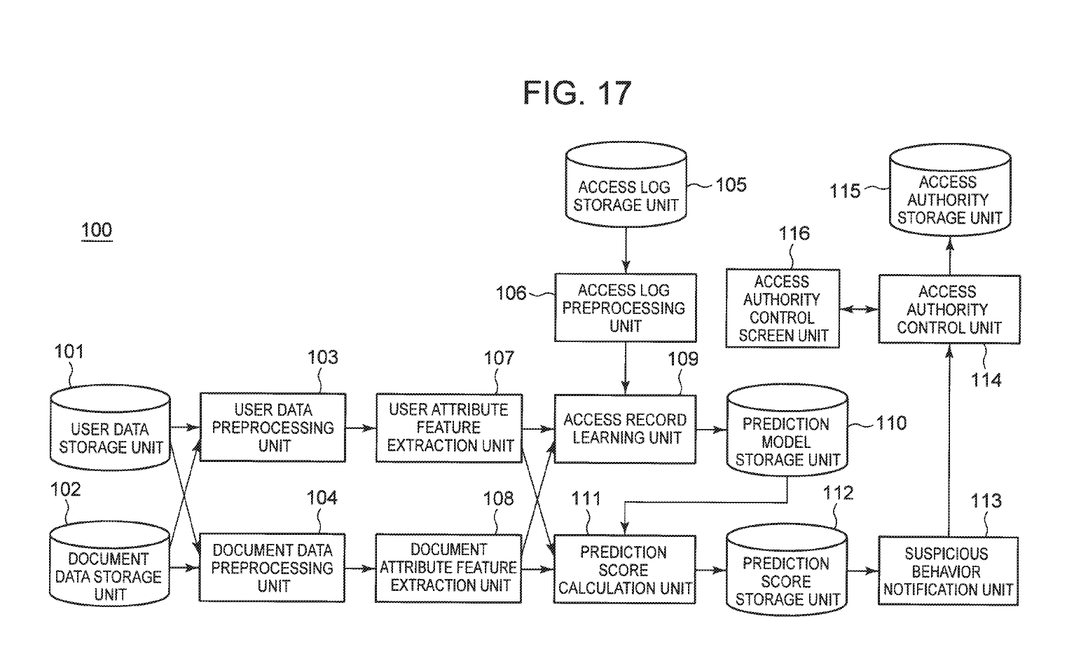

FIG. 17 is a block diagram illustrating a configuration example of a suspicious behavior detection system according to the present modification. The suspicious behavior detection system 100 illustrated in FIG. 16 differs from the configuration illustrated in FIG. 15 in that it further includes an access authority control screen unit 116.

The access authority control screen unit 116 inquires of a specific user whether to change the setting of the access authority related to suspicious behavior via the control of an access authority control screen which will be described later.

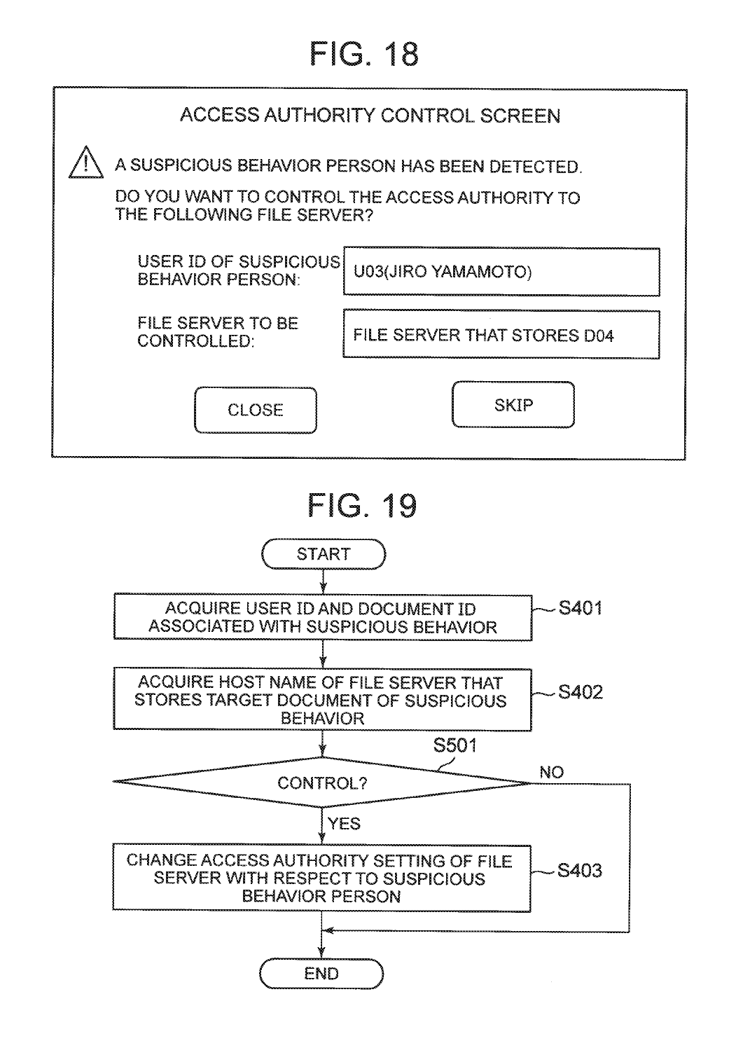

FIG. 18 is an explanatory diagram illustrating an example of the access authority control screen. As illustrated in FIG. 18, the access authority control screen may allow a user to determine whether to delete (close) or skip the current access permission setting as the access authority setting of the file server or the target document of suspicious behavior with respect to the suspicious behavior person.

FIG. 19 is a flowchart illustrating an operation example of the suspicious behavior detection system according to the present modification. Note that FIG. 19 illustrates an operation example of the access authority control step of the suspicious behavior detection system 100 according to the present modification.

In the example illustrated in FIG. 19, a determination step (step S501) for determining whether to control the access authority setting is added to the operation in the first modification illustrated in FIG. 16.

For example, in step S501, the access authority control screen unit 116 may display an access authority control screen showing at least the user ID of the detected suspicious behavior person and the host name of the file server that stores the document targeted for the suspicious behavior by the suspicious behavior person. The access authority control screen also includes user interface (UI) parts for giving an instruction as to whether to control the access authority, such as “close” and “skip” buttons. At this time, a specific user such as a person in charge of operation of the file server only needs to confirm the contents displayed on the screen and determine whether to control the access authority to make the person inaccessible to the file server.

If the specific user presses the “close” button, the access authority control screen unit 116 only needs to proceed to step S403. On the other hand, if the “skip” button is pressed, the access authority control screen unit 116 may finish the processing without doing anything.

Note that when multiple items of suspicious behavior are detected, the above processing is performed for each of them. For example, the access authority control screen unit 116 may display an access authority control screen showing, for each of the multiple items of suspicious behavior, at least the user ID of the suspicious behavior person and the host name of the file server that stores the document targeted for the suspicious behavior by the suspicious behavior person. The access authority control screen also includes, for each of the multiple items of suspicious behavior, user interface (UI) parts for giving an instruction as to whether to control the access authority, such as “close” and “skip” buttons.

Note that in the example illustrated in FIG. 18, both the user ID of the suspicious behavior person and the host name of the file server that stores the target document of the suspicious behavior by the suspicious behavior person are displayed, but only one of these pieces of information may be displayed. For example, only the user ID of a suspicious behavior person may be acquired and displayed, the user indicated by the user ID may be regarded as being at risk of performing suspicious behavior, and the access authority setting may be suggested such that the user is prohibited from accessing all data. Alternatively, for example, only the host name of the file server that stores the document targeted for suspicious behavior may be acquired and displayed, the file server or document may be regarded as being at risk of undergoing suspicious behavior, and the access authority setting may be suggested such that the file server is prohibited from being accessed by all users.

Note that the above access authority setting can be applied even when the system automatically sets the access authority.

Third Modification.

In the examples described in the present exemplary embodiment and each modification, all three steps of the access behavior learning step, the access behavior prediction step, and the suspicious behavior notification step are performed by the same device. Alternatively, the access behavior learning step can be omitted as long as a prediction model is received over a network (for example, from a delivery server or the like for prediction models published on the Internet).

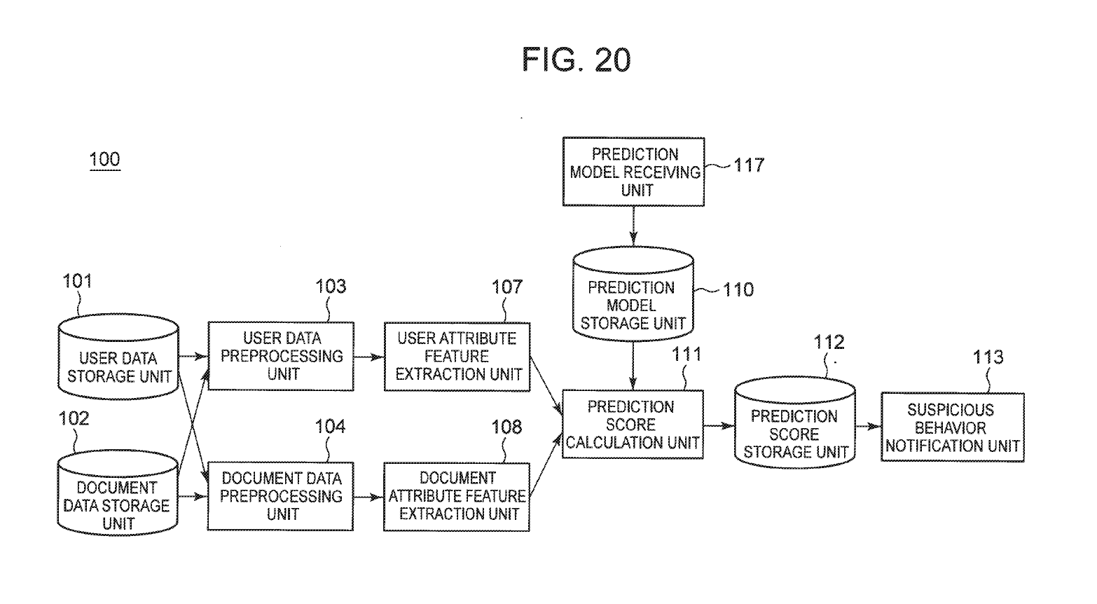

FIG. 20 is a block diagram illustrating a configuration example of a suspicious behavior detection system according to the present modification. The configuration illustrated in FIG. 20 differs from the configuration of the first modification illustrated in FIG. 7 in that the elements used only in the access behavior learning step (more specifically, the access log storage unit 105, the access log preprocessing unit 106, and the access record learning unit 109) are omitted, and a prediction model receiving unit 117 is newly added. Note that these changes can also be applied to other modifications, for example.

The prediction model receiving unit 117 receives a prediction model from the outside. A prediction model may be, for example, generated by a device other than the devices constituting the system. A prediction model to be received may not have been learned based on access behavior with respect to data targeted for suspicious behavior detection by the system. For example, a prediction model may be learned based on access information indicated by the access log accumulated in another file server or the like which has sufficient operation records or sufficient countermeasures against information leakage with the use of access authority or the like.

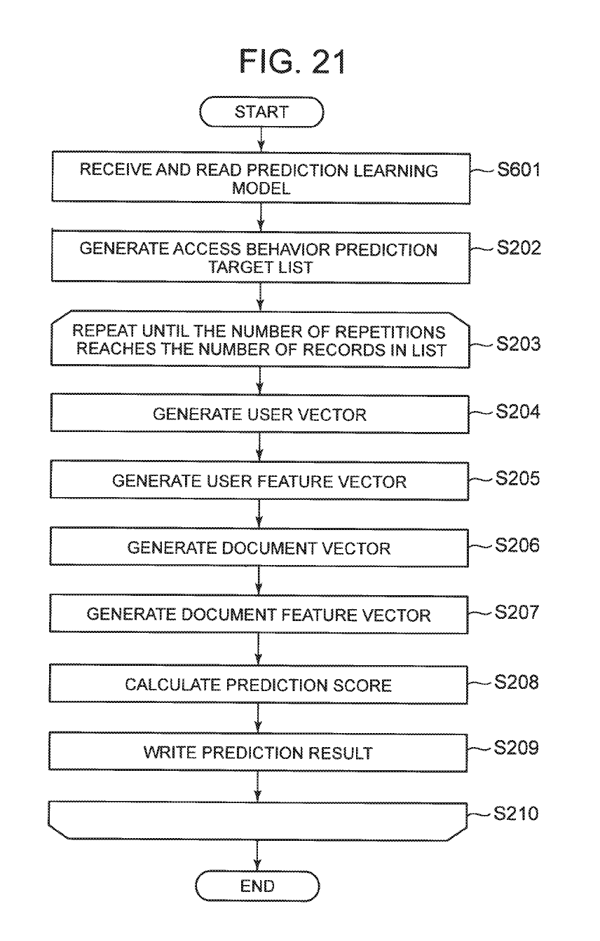

FIG. 21 is a flowchart illustrating an operation example of the suspicious behavior detection system according to the present modification. When compared with the operation example of the access behavior prediction step illustrated in FIG. 13, the example illustrated in FIG. 21 is the same as the operation of the access behavior prediction step illustrated in FIG. 13, except for a prediction model receiving/reading operation (step S601) substituted for the first prediction model reading operation (step S201). That is, in the present modification, a prediction model can be read simply by reading the prediction model received by the prediction model receiving unit 117.

For example, in step S601, the prediction model receiving unit 117 receives a prediction model via the network and writes the prediction model into the prediction model storage unit 110. Then, the prediction score calculation unit 111 reads the prediction model from the prediction model storage unit 110.

According to the present modification, a highly accurate prediction model can be used even when the access log accumulation in the host system is not sufficient or when the processing capability necessary for model generation is not sufficient.

Fourth Modification.

Next, a fourth modification of the present exemplary embodiment will be described. The above description is based on the assumption that two pieces of input data, namely, user data and document data, are used as input data for learning and prediction. Alternatively, in the access behavior learning step and the access behavior prediction step, three or more pieces of input data (N pieces of input data) can be processed.

For example, suppose the following three pieces of data exist as user data. That is, user data is roughly classified into (a) what is called attribute data (data concerning the user himself/herself such as the information illustrated in FIG. 8), (b) SNS data generated in SNS and the like, and (c) statistical data such as statistical values about access behavior performed by the user on predetermined data.

In such a case, the system only needs to generate a user feature vector from each of the above three pieces of data in the same way as the above vectorization, and merge the generated three user feature vectors into a single user feature vector (connect and synthesize an A-dimensional vector, a B-dimensional vector, a C-dimensional vector, and the like into a (A+B+C+ . . . )-dimensional vector. This also applies to document data.

As a result, even N pieces of input data can be classified into user data or document data depending on whether they are derived from the user or data, and merged into two pieces of input data.

Fifth Modification.

Next, a fifth modification of the present exemplary embodiment will be described. In the above description of the present exemplary embodiment, it is determined whether access behavior is suspicious behavior with respect to a set of <user ID, document ID> associated with access behavior extracted from a particularly designated period (prediction period) of the access log. However, the access behavior to be predicted is not limited to what is indicated by such an access log. For example, it is also possible to predict dangerous documents and dangerous users in advance, instead of handling actual access behavior. Here, a dangerous document is a document or group of documents which is likely to be subject to suspicious behavior for a specific user or group of users, more specifically, a document or group of documents which is less likely to be accessed by the specific user or group of users. A dangerous user is a user or group of users who is likely to be the subject of suspicious behavior for specific data or a specific group of data, more specifically, a user or group of users who is less likely to access the specific data or the specific group of data. By predicting dangerous documents and dangerous users in advance, it is possible to perform advance prevention such as, for example, preliminarily restricting access to a dangerous document by a specific user or access to a specific document by a dangerous user.

A method of predicting a dangerous user according to the present modification only needs to include, for example, when generating an access behavior prediction target list in step S202 of the access behavior prediction step, adding, to the access behavior prediction target list, combinations of all the document IDs and the user IDs (specific user IDs) of users to be examined. Note that in a case where input data used for prediction includes information other than the information obtained from user IDs and document IDs (for example, access time zone, etc.), the access behavior prediction target list only needs to contain combinations of patterns of all possible values of the input data other than the user data and specific user IDs.

Then, step S203 and the following steps can be executed simply by using the access behavior prediction target list generated in this way. As a result, if there is at least one set determined as suspicious behavior, the user indicated by the specific user ID included in this set may be regarded as a dangerous user associated with at least the access behavior indicated by this set.

Similarly, predicting a dangerous document according to the present modification only needs to include, for example, when generating an access behavior prediction target list in step S202 of the access behavior prediction step, adding, to the access behavior prediction target list, combinations of all the user IDs and document IDs (specific document IDs) of documents to be examined. Note that in a case where input data used for prediction includes information other than the information obtained from user IDs and document IDs (for example, access time zone, etc.), the access behavior prediction target list only needs to contain combinations of patterns of all possible values of the input data other than the document data and specific document IDs.

Then, step S203 and the following steps can be executed simply by using the access behavior prediction target list generated in this way. As a result, if there is at least one set determined as suspicious behavior, the document indicated by the specific document ID included in this set may be regarded as a dangerous document associated with at least the access behavior indicated by this set.

In addition, when a dangerous user or dangerous document is detected, the system may execute the operation of the suspicious behavior notification step.

Although the present invention has been described with reference to the exemplary embodiments and examples, the present invention is not limited to the above-described exemplary embodiments and examples. Various changes that can be understood by those skilled in the art can be made to the configurations and details of the present invention within the scope of the present invention.

For example, one of the features of the present invention is to perform machine learning based on data indicating users' past behavior concerning data access and to determine whether unknown data access behavior is suspicious behavior. In the examples described in many of the above descriptions, learning is performed by attaching a correct/incorrect label. to two pieces of input (a one-to-one combination of user data and document data obtained from an access log). However, since one of the objects of the present invention can be achieved as long as behavior-based access control can be performed through machine learning, input used for learning is not limited to the above. Targets to be monitored are also not limited to file servers managed by the information system division of a company or the like.

Examples of preferable items to be included in input data include pieces of information on data access behavior corresponding to the following 5W1H.

WHO: Users' profile (name, age, position, job, health status, manager's evaluation, etc.)

WHEN: Date users accessed data (weekdays, holidays, daytime, nighttime, etc.)

WHERE: Where users accessed data (file server, database, SNS, etc.)

WHAT: Data accessed by users (title, property, contents, etc.)

WHY: Reason why users accessed data (read, write, copy, delete, etc.)

HOW: Way users accessed data (access terminal, access route, etc.)

In the second exemplary embodiment, for example, in a case where the number of dimensions of vectors generated by the user data preprocessing unit 103 and the document data preprocessing unit 104 is not so large, the feature extraction units (user attribute feature extraction unit 107 and document attribute feature extraction unit 108) may be omitted.

Each of the above exemplary embodiments can also be described as in the following supplementary notes.

(Supplementary note 1) An information-processing device including: model storage means that stores an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed; and determination means that determines whether arbitrary data access behavior is suspicious behavior based on the access behavior model.

(Supplementary note 2) The information-processing device according to supplementary note 1, wherein the access information includes, as the first piece of information, information on the user who accesses the data, an access time, an access type, or an access method, or includes, as the second piece of information, information on the data itself or a storage location of the data.

(Supplementary note 3) The information-processing device according to supplementary note 2, wherein the access information includes, as the information on the user who accesses the data, information on a text generated by the user or a statistical value about access behavior performed by the user on predetermined data, or includes, as the information on the data itself, information on contents of the data or a statistical value about access behavior performed on the data.

(Supplementary note 4) The information-processing device according to any of supplementary notes 1 to 3, including learning means that generates the access behavior model through machine learning using, as learning data, access information and information indicating whether the data access behavior indicated by the access information is the suspicious behavior.

(Supplementary note 5) The information-processing device according to any of supplementary notes 1 to 4, the information-processing device being configured to set a file managed by a file server as target data, wherein the model storage means stores the access behavior model learned through machine learning using access information about access behavior in a designated period among items of access behavior included in an access history for a predetermined file, and using information capable of determining whether the access behavior is the suspicious behavior.

(Supplementary note 6) The information-processing device according to any of supplementary notes 1 to 5, including numerical vector generation means that generates, from the access information, two or more numerical vectors, each including a multidimensional numerical value, wherein the model storage means stores the access behavior model indicating a relationship between a set of the two or more numerical vectors and the suspicious behavior or the normal behavior, and based on a probability of the suspicious behavior or the normal behavior with respect to a set of two or more numerical vectors generated from designated access information, the probability being calculated using the access behavior model, the determination means determines whether the data access behavior indicated by the access information is the suspicious behavior.

(Supplementary note 7) The information-processing device according to supplementary note 6, including, as the numerical vector generation means: first numerical vector generation means that generates a first numerical vector including a multidimensional numerical value from the first piece of information included in the access information; and second numerical vector generation means that generates a second numerical vector including a multidimensional numerical value from the second piece of information included in the access information, wherein the model storage means stores the access behavior model indicating a relationship between a set of the first numerical vector and the second numerical vector and the suspicious behavior or the normal behavior, and based on a probability of the suspicious behavior or the normal behavior with respect to a set of the first numerical vector and the second numerical vector generated from the first piece of information and the second piece of information included in designated access information, the probability being calculated using the access behavior model, the determination means determines whether the data access behavior indicated by the access information is the suspicious behavior.

(Supplementary note 8) The information-processing device according to any of supplementary notes 1 to 7, including dangerous data prediction means that predicts, based on the access behavior model, data that is at risk of undergoing access behavior corresponding to the suspicious behavior.

(Supplementary note 9) The information-processing device according to any of supplementary notes 1 to 8, including dangerous user prediction means that predicts, based on the access behavior model, a user who is at risk of performing data access behavior corresponding to the suspicious behavior.

(Supplementary note 10) The information-processing device according to any of supplementary notes 1 to 9, including access authority changing means that changes access authority based on a determination result by the determination means.

(Supplementary note 11) The information-processing device according to any of supplementary notes 1 to 10, including: suspicious behavior detection means that detects the suspicious behavior from actual data access behavior based on determination result by the determination means; and notification means that notifies an administrator in response to the suspicious behavior being detected.

(Supplementary note 12) A suspicious behavior detection system including: learning means that generates through machine learning an access behavior model indicating a relationship between arbitrary access information and suspicious behavior or normal behavior, the access behavior model being generated using, as learning data, access information and information capable of determining whether data access behavior indicated by the access information is the suspicious behavior, the access information being about data access behavior that is a user's behavior with respect to data, the access information including a first piece of information derived from the user who accesses the data and a second piece of information derived from the data accessed; model storage means that stores the access behavior model; a determination means that determines whether arbitrary data access behavior is the suspicious behavior based on the access behavior model; and suspicious behavior detection means that detects the suspicious behavior from actual data access behavior based on a determination result.

(Supplementary note 13) A suspicious behavior detection method including determining, by an information-processing device, whether arbitrary data access behavior is suspicious behavior based on an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed.

(Supplementary note 14) A suspicious behavior detection program for causing a computer to execute a process of determining whether arbitrary data access behavior is suspicious behavior based on an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed.

This application claims priority based on Japanese Patent Application No. 2015-202280 filed on Oct. 13, 2015, the disclosure of which is incorporated herein in its entirety.

### INDUSTRIAL APPLICABILITY

Since the present invention is characterized by performing model learning by extracting feature amounts related to users and data from input data, for example, the present invention can be applied to a business model that provides only a prediction model for detecting suspicious behavior with a high degree of accuracy.

### REFERENCE SIGNS LIST

10, 100 Suspicious behavior detection system
11 Model storage means
12 Determination means
13 Learning means
14 Suspicious behavior detection means
15 Notification means
16 Numerical vector generation means
161 First numerical vector generation means
162 Second numerical vector generation means
17 Dangerous user prediction means
18 Dangerous data prediction means
19 Access authority changing means
101 User data storage unit
102 Document data storage unit
103 User data preprocessing unit
104 Document data preprocessing unit
105 Access log storage unit
106 Access log preprocessing unit
107 User attribute feature extraction unit
108 Document attribute feature extraction unit
109 Access record learning unit
110 Prediction model storage unit
111 Prediction score calculation unit
112 Prediction score storage unit
113 Suspicious behavior notification unit
114 Access authority control unit
115 Access authority storage unit
116 Access authority control screen unit
117 Prediction model receiving unit

1. An information-processing device comprising:
a model storage unit that stores an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed; and
a determination unit implemented at least by a hardware including a processor and determines whether arbitrary data access behavior is suspicious behavior based on the access behavior model.

2. The information-processing device according to claim 1, wherein
the access information includes, as the first piece of information, information on the user who accesses the data, an access time, an access type, or an access method, or includes, as the second piece of information, information on the data itself or a storage location of the data.

3. The information-processing device according to claim 2, wherein
the access information includes, as the information on the user who accesses the data, information on a text generated by the user or a statistical value about access behavior performed by the user on predetermined data, or includes, as the information on the data itself, information on contents of the data or a statistical value about access behavior performed on the data.

4. The information-processing device according to claim 1, comprising
a learning unit implemented at least by the hardware and generates the access behavior model through machine learning using, as learning data, access information and information indicating whether the data access behavior indicated by the access information is the suspicious behavior.

5. The information-processing device according to claim 1, the information-processing device being configured to set a file managed by a file server as target data, wherein
the model storage unit stores the access behavior model learned through machine learning using access information about access behavior in a designated period among items of access behavior included in an access history for a predetermined file, and using information capable of determining whether the access behavior is the suspicious behavior.

6. The information-processing device according to claim 1, comprising
a numerical vector generation unit implemented at least by the hardware and generates, from the access information, two or more numerical vectors, each including a multidimensional numerical value, wherein
the model storage unit stores the access behavior model indicating a relationship between a set of the two or more numerical vectors and the suspicious behavior or the normal behavior, and
based on a probability of the suspicious behavior or the normal behavior with respect to a set of two or more numerical vectors generated from designated access information, the probability being calculated using the access behavior model, the determination unit determines whether the data access behavior indicated by the access information is the suspicious behavior.

7. The information-processing device according to claim 6, comprising, as the numerical vector generation unit:
a first numerical vector generation unit implemented at least by the hardware and generates a first numerical vector including a multidimensional numerical value from the first piece of information included in the access information; and
a second numerical vector generation unit implemented at least by the hardware and generates a second numerical vector including a multidimensional numerical value from the second piece of information included in the access information, wherein
the model storage unit stores the access behavior model indicating a relationship between a set of the first numerical vector and the second numerical vector and the suspicious behavior or the normal behavior, and
based on a probability of the suspicious behavior or the normal behavior with respect to a set of the first numerical vector and the second numerical vector generated from the first piece of information and the second piece of information included in designated access information, the probability being calculated using the access behavior model, the determination unit determines whether the data access behavior indicated by the access information is the suspicious behavior.

8. The information-processing device according to claim 1, comprising
a dangerous data prediction unit implemented at least by the hardware and predicts, based on the access behavior model, data that is at risk of undergoing access behavior corresponding to the suspicious behavior.

9. The information-processing device according to claim 1, comprising
a dangerous user prediction unit implemented at least by the hardware and predicts, based on the access behavior model, a user who is at risk of performing data access behavior corresponding to the suspicious behavior.

10. The information-processing device according to claim 1, comprising
an access authority changing unit implemented at least by the hardware and changes access authority based on a determination result by the determination unit.

11. The information-processing device according to claim 1, comprising:
a suspicious behavior detection unit implemented at least by the hardware and detects the suspicious behavior from actual data access behavior based on a determination result by the determination unit; and
a notification unit implemented at least by the hardware and notifies an administrator in response to the suspicious behavior being detected.

12. A suspicious behavior detection system comprising:
a learning unit implemented at least by a hardware including a processor and generates through machine learning an access behavior model indicating a relationship between arbitrary access information and suspicious behavior or normal behavior, the access behavior model being generated using, as learning data, access information and information capable of determining whether data access behavior indicated by the access information is the suspicious behavior, the access information being about data access behavior that is a user's behavior with respect to data, the access information including a first piece of information derived from the user who accesses the data and a second piece of information derived from the data accessed;
a model storage unit that stores the access behavior model;
a determination unit implemented at least by a hardware including a processor and determines whether arbitrary data access behavior is the suspicious behavior based on the access behavior model; and
a suspicious behavior detection unit implemented at least by the hardware and detects the suspicious behavior from actual data access behavior based on a determination result.

13. A suspicious behavior detection method comprising
determining, by an information-processing device, whether arbitrary data access behavior is suspicious behavior based on an access behavior model indicating a relationship between access information and suspicious behavior or normal behavior, the access information being about data access behavior that is a user's behavior with respect to data, the access information including a first piece of information derived from the user who accesses the data and a second piece of information derived from the data accessed.

14. (canceled)
